(19) United States
(12) Patent Application Publication
(10) Pub. No.: US 2015/0282091 A1
(43) Pub. Date: Oct. 1, 2015

(54) Method for DSDS/DSDA Idle Power Optimization by Adaptive RF Power Retention and Delta Programming

(71) Applicant: QUALCOMM Incorporated, San Diego, CA (US)

(72) Inventors: Jeremy Huei Lin, San Diego, CA (US); Rahul Kashyap, San Diego, CA (US); Ping Zhou, San Diego, CA (US); RaviTeja Yarra, Hyderabad (IN); Prashanth Akula, San Diego, CA (US); Kevin Hsi-huai Wang, San Diego, CA (US); Anil Satyanarayana Rao, San Diego, CA (US); Ali Taha, San Diego, CA (US); Subbarayudu Mutya, Hyderabad (IN)

(73) Assignee: QUALCOMM Incorporated, San Diego, CA (US)

(21) Appl. No.: 14/228,618

(22) Filed: Mar. 28, 2014

(51) Int. Cl. H04W 52/02; H04W 24/02

(52) U.S. Cl. CPC H04W 52/0274; H04W 24/02; H04W 88/06

(57) ABSTRACT

Various embodiments in the disclosure provide methods implemented by a processor executing on a mobile communication device to dynamically determining whether the power saved by powering down the RF chain between the end of the last reception activities and the beginning of the next reception activities will exceed the power expended to reinitialize the RF chain's components and registers for the next reception activities. Based on this determination, the device processor may configure the RF chain either to power down fully, as in conventional implementations, or to enter a low-power mode in which power is maintained to the power rails supplying the memory registers storing RF communication data, thereby avoiding the power surge of restarting the registers and part of the power drain associated with writing the communication data back into the registers. In some embodiments, the mobile communication device may be a multi-SIM device.

### BACKGROUND

Some new designs of mobile communication devices—such as smart phones, tablet computers, and laptop computers—contain two or more Subscriber Identity Module (“SIM”) cards that provide users with access to multiple separate mobile telephony networks. Examples of mobile telephony networks include GSM, TD-SCDMA, CDMA2000, and WCDMA. Example mobile communication devices that include multiple SIMs include mobile phones, laptop computers, smart phones, and other mobile communication devices that are configured to connect to multiple mobile telephony networks. A mobile communication device that includes a plurality of SIMs and connects to two or more separate mobile telephony networks using one or more separate radio frequency (“RF”) chains/resources is termed a “multi-SIM” communication device. An example multi-SIM communication device is a “dual-SIM-dual-active” or “DSDA” communication device, which includes two SIM cards/subscriptions that utilize two separate RF chains to communicate with two separate mobile telephony networks. Another example multi-SIM communication device is a “dual-SIM-dual-standby” or “DSDS” communication device, which includes two SIM cards/subscriptions that share one RF chain to communicate with two separate mobile telephony networks.

On a multi-SIM communication device, when a SIM/subscription is not engaged in an active data/voice call, the subscription enters an “idle-standby mode.” In the idle-standby mode, the subscription periodically utilizes an RF chain to perform discontinuous reception (“DRX”) of network paging messages in order to remain connected to the network. At the conclusion of the subscription's paging activities, the RF chain is powered down to conserve power until the RF chain is needed to service the next set of reception activities, at which time the RF chain is powered up.

An RF chain operating on a multi-SIM communication device may service multiple subscriptions, and the reception activities of these subscriptions may occur in short intervals, such as when the DRX cycles of two or more subscriptions do not overlap and/or are of different lengths. In these circumstances, the RF chain may quickly alternate between powering down after servicing one subscription's reception activities and powering up to handle another subscription's reception activities, thereby potentially reducing the effectiveness of powering down the RF chain between reception activities to save power.

### SUMMARY

Various embodiments provide methods, devices, and non-transitory processor-readable storage media for dynamically managing power usage of a radio-frequency (RF) chain on a mobile communication device.

Some embodiment methods may include determining a period of time that the RF chain will not be transmitting or receiving, determining whether powering down the RF chain for the determined period of time would yield net power savings, placing the RF chain in a low-power mode that retains values stored in configuration registers of the RF chain in response to determining that powering down the RF chain for the determined period of time would not yield net power savings, and powering down the RF chain in response to determining that powering down the RF chain for the determined period of time would yield net power savings. When the RF chain is powered down, values stored in the configuration registers are not maintained, and the RF chain is in a state that draws less power than when the RF chain is in the low-power mode.

In some embodiments, determining whether powering down the RF chain for the determined period of time would yield net power savings may also include determining whether powering down the RF chain for the determined period of time would yield net power savings based on a period of time required to power up the RF chain.

In some embodiments, the mobile communication device may be a multi-Subscriber-Identity-Module (multi-SIM) communication device that includes at least one subscription and at least one RF chain.

In some embodiments, determining a period of time that the RF chain will not be transmitting or receiving may include determining a period of time the RF chain will be idle based on an end time of currently serviced reception activities and a start time of upcoming reception activities.

In some embodiments, determining whether powering down the RF chain for the determined period of time would yield net power savings may include determining a minimum amount of time that the RF chain must be powered down to achieve net power savings and determining whether the minimum amount of time exceeds the determined period of time, and placing the RF chain in a low-power mode that retains values stored in configuration registers of the RF chain may include placing the RF chain in the low-power mode in response to determining that the minimum amount of time exceeds the determined period of time.

In some embodiments, the methods may include determining whether a subscription associated with upcoming reception activities matches a subscription associated with reception activities the RF chain serviced most recently and updating only those configuration registers of the RF chain that are specific to the subscription associated with the upcoming reception activities in response to determining that the subscription associated with the upcoming reception activities does not match the subscription associated with the most recent reception activities.

In some embodiments, updating only configuration registers specific to the subscription associated with the upcoming reception activities may include determining a communication protocol of the subscription associated with the upcoming reception activities, performing a table lookup to identify configuration registers of the RF chain associated with enabling the RF chain to use the communication protocol, and updating only the identified configuration registers to enable the RF chain to service the subscription associated with the upcoming reception activities.

In some embodiments, determining whether powering down the RF chain for the determined period of time would yield net power savings may include calculating an expected power usage associated with powering down the RF chain for the determined period of time, calculating an expected power usage associated with placing the RF chain in the low-power mode for the determined period of time, and determining whether the expected power usage associated with powering down the RF chain exceeds the expected power usage associated with placing the RF chain in the low-power mode.

In some embodiments, placing the RF chain in a low-power mode that retains values stored in configuration registers of the RF chain may include placing the RF chain in the low-power mode in response to determining that the expected power usage associated with powering down the RF chain exceeds the expected power usage associated with placing the RF chain in the low-power mode.

In some embodiments, calculating an expected power usage associated with powering down the RF chain for the determined period of time may include determining an amount of power required to reinitialize components of the RF chain that would be powered down during the determined period of time, determining an amount of power required to rewrite all the configuration registers of the RF chain, and calculating the expected power usage associated with powering down the RF chain as a sum of the determined amount of power required to power up the components of the RF chain and the determined amount of power required to rewrite all of the configuration registers of the RF chain.

In some embodiments, calculating an expected power usage associated with placing the RF chain in the low-power mode may include determining an amount of power required to maintain the values stored in the configuration registers of the RF chain during the determined period of time, determining an amount of power required to update only configuration registers of the RF chain specific to a subscription associated with upcoming reception activities, and calculating the expected power usage associated with placing the RF chain in the low-power mode as a sum of the determined amount of power required to maintain the values stored in the configuration registers of the RF chain and the determined amount of power required to update only the configuration registers specific to the subscription associated with the upcoming reception activities.

Various embodiments may include a mobile communication device configured with processor-executable instructions to perform operations of the methods described above.

Various embodiments may include a mobile communication device having means for performing functions of the operations of the methods described above.

Various embodiments may include non-transitory processor-readable media on which are stored processor-executable instructions configured to cause a processor of a mobile communication device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of mobile telephony networks suitable for use with various embodiments.

FIG. 2 is a component block diagram of a multi-SIM communication device according to various embodiments.

FIG. 3 is a component block diagram illustrating the interaction between components of different transmit/receive chains in a multi-SIM communication device according to various embodiments.

FIG. 4A is a timeline diagram illustrating the power usage and configuration registers of an RF chain servicing a subscription's reception activities on a conventional mobile communication device.

FIG. 4B is a timeline diagram illustrating the power usage and configuration registers of an RF chain servicing multiple subscriptions' reception activities on a conventional multi-SIM communication device.

FIG. 5 is a timeline diagram illustrating dynamic power management of an RF that is servicing multiple subscriptions' reception activities according to various embodiments.

FIG. 6 is a process flow diagram illustrating a method for determining whether to power down an RF chain between reception activities of one or more subscriptions according to various embodiments.

FIG. 7 is a process flow diagram illustrating a method for determining whether to power down an RF chain between reception activities based on a period of time the RF chain is idle between the reception activities according to various embodiments.

FIG. 8 is a process flow diagram illustrating a method for determining whether to power down an RF chain between reception activities based on a comparison of the expected power usage associated with powering down the RF chain and the expected power usage associated with placing the RF chain in a low-power mode to retain the values stored in the RF chain's configuration registers according to various embodiments.

FIG. 9 is a process flow diagram illustrating a method for performing a table lookup to update only configuration registers associated with enabling an RF chain to service upcoming reception activities according to various embodiments.

FIG. 10 is a component block diagram of a multi-SIM communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “multi-SIM communication device” refers to any one or all of cellular telephones, smart phones, personal or mobile multi-media players, personal data assistants, laptop computers, tablet computers, smart books, palm-top computers, wireless electronic mail receivers, multimedia Internet-enabled cellular telephones, wireless gaming controllers, and similar personal electronic devices that include a plurality of SIM cards, a programmable processor, memory, and circuitry for connecting to at least two mobile communication network. Various embodiments may be useful in mobile communication devices, such as smart phones, and so such devices are referred to in the descriptions of various embodiments. However, the embodiments may be useful in any electronic devices that may individually maintain at least one subscription and at least one RF chain, which may include one or more of antennae, radios, transceivers, etc.

As used herein, the terms “SIM”, “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the terms “SIM” and “subscription” are used interchangeably and are used herein as a shorthand reference to refer to the communication service associated with and enabled by the information stored in a particular SIM as the SIM and the communication network, as well as the services and subscriptions supported by that network, correlate to one another.

As described, in current multi-SIM communication devices, the subscription's RF chain is powered down to reduce overall power usage when the subscription is not performing reception activities (i.e., DRX). As a result of powering down, the information needed to enable the subscription's communications with its network that is stored in the RF chain's configuration registers is lost. As a result, when the RF chain powers up at the subscription's next wakeup time, the RF chain experiences a spike in power usage caused by an inrush of power needed to reactivate and reload powered-down registers. This power usage spike to restart an RF chain reduces the amount of power saved by powering down the RF chain. Also, because the RF chain's configuration registers are lost when the RF chain is powered down, restarting the RF chain requires rewriting all of its configuration registers, adding to the power-up time and consuming power. Therefore, the amount of energy conserved by powering off the RF chain between the subscription reception activities is reduced by the amount of power surge upon reactivating the RF chain's registers and the power consumed in saving data to its registers. If the power-off duration is too short, there may be no net energy savings because the power expended reactivating RF chains and reinitializing RF configuration registers would exceed the energy savings from powering down the RF chains between the subscription's reception activities.

The problem of balancing power savings from powering down an RF chain during the idle time versus the power consumed by powering up the RF chain is of particular concern in a multi-SIM communication device because the multiple subscriptions serviced by the RF chain can lead to shorter idle periods between when one subscription ends a receive operation and the next subscription begins a receive operation. Also, because the DRX cycles of different network technologies differ, the various subscriptions' DRX cycles will tend to stagger, so that part of the time the effective idle period will be shorter (e.g., approximately half of a normal DRX cycle) while periodically the reception actions will overlap, resulting in idle periods approaching the DRX cycle of a single subscription. Consequently, always powering down an RF chain at the end of a reception activity on a multi-SIM communication device may result in reduced power savings because some idle periods will not be long enough to result in a net power savings. Also, using a fixed idle duration (such as one half of the DRX cycle interval) would not be able to take advantage of the longer intervals between reception operations that occur when two (or more) subscription DRX cycles align (i.e., approximately overlap).

In overview, various embodiments provide methods implemented by a processor executing on a mobile communication device to dynamically determine whether the power that will be saved by powering down the RF chain between the end of the last reception activities and the beginning of the next reception activities will exceed the power expended to reinitialize the RF chain's components and registers for the next reception activities. Based on this determination, the device processor may configure the RF chain either to power down fully, as in conventional implementations, or to enter a low-power mode in which power is maintained to power rails supplying the memory registers storing RF communication data, thereby avoiding the power surge of restarting the registers and part of the power drain associated with writing the communication data back into the registers. When the power saved by powering down the RF chain exceeds the power expended reinitializing the RF chain components and reloading the configuration registers, the RF chain may be fully powered down, in which case values stored in the configuration registers are not maintained, and the RF chain is in a state that draws less power than when the RF chain is in the low-power mode.

Various embodiments may be useful in mobile communication devices that include multiple subscriptions that have different DRX cycles lengths because the different DRX cycles may occasionally cause an RF chain to be idle for periods of time that are too short to achieve net power savings by powering down the RF chain completely. Because mobile communication devices with multiple SIMs/subscriptions may receive particular benefit from various embodiments, such multi-SIM communication devices are referred to in the descriptions of various embodiments. However, the embodiments may be useful in any mobile communication device (e.g., a dual-SIM-dual-active communication device or a single-SIM communication device) that maintains at least one SIM/subscription and at least one RF chain.

In various embodiments, the multi-SIM communication device processor may compare the amount of time the RF chain is expected to be idle to a time threshold value that represents a minimum amount of time that the RF chain needs to be fully powered down in order to achieve positive net power savings. In some embodiments, the device processor may calculate the RF chain's idle time based on the DRX cycle length of the RF chain's subscription. In some embodiments, the device processor may calculate the RF chain's idle time as the length of time between the end of the last reception activities associated with a subscription and a start of the upcoming reception activities (i.e., the next wakeup or start time), which may be associated with the same subscription or with a different subscription.

In alternative embodiments, rather than calculating the RF chain's idle time, the device processor may make the above determination by explicitly calculating the expected power usage associated with powering down the RF chain while the RF chain is idle, calculating the expected power usage associated with maintaining the power rails connected to the configuration registers of the RF chain while the RF chain is in a low-power mode, and comparing those expected power usage calculations. In such embodiments, based on the comparison, the device processor may power down the RF chain or place the RF chain in a low-power mode in order to use the least amount of power until the next reception activities begin.

In response to determining that the RF chain's expected idle time exceeds the minimum time threshold (or that completely powering down the RF chain would use less power than maintaining the RF chain's configuration registers), the device processor may configure the RF chain to power down fully until the next wakeup time as currently practiced. When the RF chain is fully powered down, the values stored in the configuration registers are not maintained, and the RF chain is in a state that draws less power than when the RF chain is in the low-power mode.

In response to determining that the RF chain's expected idle time is less than the minimum time threshold (or that maintaining the RF chain's configuration registers in a low-power mode would use less power than completely powering down the RF chain), the device processor may configure the RF chain to enter a low-power mode that maintains power to register power rails until the next reception activities are scheduled to begin. In other words, the device processor may implement a low-power mode in which power rails connected to the RF chain's configuration registers remain on while the rest of the RF chain is powered down in order to maintain the data stored in those registers during the idle period. By preserving the RF chain's configuration register values while the RF chain is idle, the power surge associated with restarting the registers is avoided and some of the communication data in the RF chain's configuration registers does not need to be written to the registers at the next wakeup time. While powering the registers while the rest of the RF chain is powered down consumes power, the net power consumed to maintain the data in the registers during this time is less than the power that would be consumed in the power surge and data storing operations required to reinitialize the registers.

In some embodiments, retaining some of the communication data in the RF chain registers may be leveraged to reduce the time needed to reinitialize the RF chain by enabling the initialization process to be limited to only rewriting those registers associated with enabling communications via a different communication protocol. Typically, some of the data stored in the RF chain registers will be applicable for two or more subscriptions sharing the RF chain. By leaving the registers powered during brief idle periods, such common data does not have to be re-written into the registers. For example, the device processor may identify configuration registers associated with a communication protocol related to upcoming reception activities via a table lookup, and the device processor may update only those identified configuration registers necessary to enable the RF chain to use that communication protocol to service the upcoming reception activities. As a result, the device processor may perform fewer data writes (and bus access operations) to initiate the next reception activity, thus decreasing the amount of time needed to reinitialize the RF chain's configuration registers and decreasing overall power usage.

Regardless of whether the RF chain is powered down or placed in the low-power mode, it may take some time for the RF chain to be powered up fully, stabilized, and ready to transmit or receive. This is referred to as latency. Thus, in some embodiments, the device processor's determination regarding whether powering down an RF chain or placing the RF chain in a low-power mode that retains its register values during an idle period may account for the amount of time needed to power up the RF chain (i.e., the power up latency of the RF chain) before the start of the next reception activities (i.e., the latency of powering up the RF chain).

In such embodiments, the device processor may compare an expected period of time that the RF chain will not transmit or receive (e.g., an idle period) with the RF chain power-up latency (i.e., the time needed to return the RF chain to operation from the fully powering state), which may be a pre-defined constant, determined based on prior power up timing, or received as a value from a third party. In response to determining that the RF chain power-up latency exceeds the expected idle period, the device processor may not power down the RF chain because there would not be enough time to power up the RF chain before the RF chain is schedule to next perform reception or transmission activities. Thus, a decision to power down or enter a low-power mode may also be based on whether the RF chain will be off long enough to enable the power-down/power-up cycle to be completed.

As described, implementing a low-power mode that retains configuration register value may reduce the amount of time required to reactivate the RF chain because fewer data values may need to be written to the registers. Thus, implementing a low-power mode that leaves on the power rails to the configuration registers may enable powering down the rest of the RF chain when the expected period of time that the RF chain will not transmit or receive is not long enough for a complete power-down and power-up cycle. Thus, in some embodiments, the expected period of time that the RF chain will not transmit or receive may be compared to the minimum time required to reenergize and stabilize the RF chain plus the time required to write data to those registers that require new data. As the amount of registers that must be changed may depend upon the particular circumstances (including the amount of overlap in register data between the previous technology and the next technology) this latency threshold time may be determined dynamically.

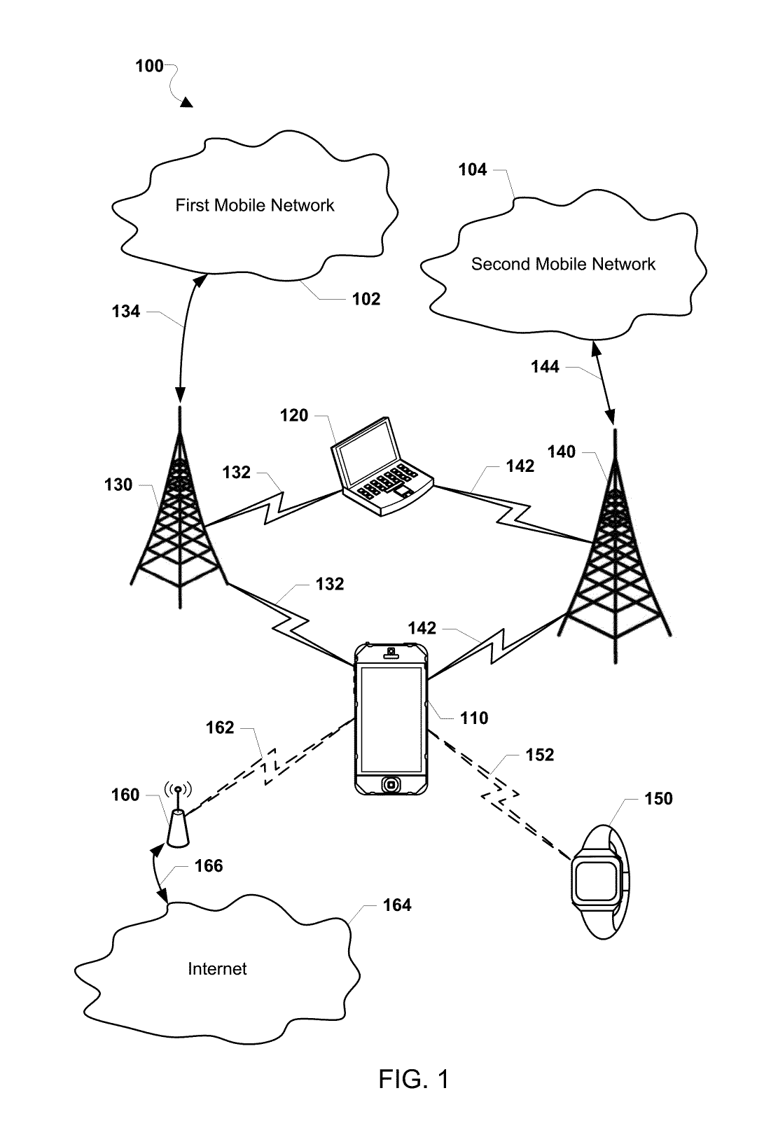

Various embodiments may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first multi-SIM communication device 110 may be in communication with the first mobile network 102 through a cellular connection 132 to the first base station 130. The first multi-SIM communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second multi-SIM communication device 120 may similarly communicate with the first mobile network 102 through the cellular connection 132 to the first base station 130. The second multi-SIM communication device 120 may also communicate with the second mobile network 104 through the cellular connection 142 to the second base station 140. The cellular connections 132 and 142 may be made through two-way wireless communication links, such as 4G, 3G, CDMA, TDMA, WCDMA, GSM, and other mobile telephony communication technologies.

While the multi-SIM communication devices 110, 120 are shown connected to the mobile network 102 and, optionally, to the mobile network 104, in some embodiments (not shown), the multi-SIM communication devices 110, 120 may include two or more subscriptions to two or more mobile networks and may connect to those subscriptions in a manner similar to those described above.

In some embodiments, the first multi-SIM communication device 110 may optionally establish a wireless connection 152 with a peripheral device 150 used in connection with the first multi-SIM communication device 110. For example, the first multi-SIM communication device 110 may communicate over a Bluetooth® link with a Bluetooth-enabled personal computing device (e.g., a “smart watch”). In some embodiments, the first multi-SIM communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second multi-SIM communication device 120 may similarly be configured to connect with the peripheral device 150 and/or the wireless access point 160 over wireless links.

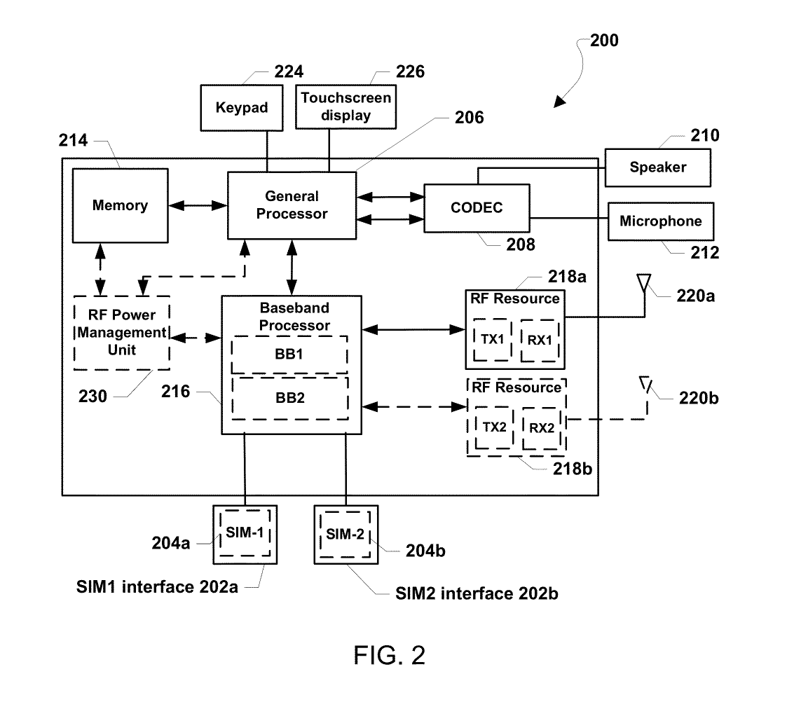

FIG. 2 is a functional block diagram of a multi-SIM communication device 200 suitable for implementing various embodiments. According to various embodiments, the multi-SIM communication device 200 may be similar to one or more of the multi-SIM communication devices 110, 120 as described with reference to FIG. 1. With reference to FIGS. 1-2, the multi-SIM communication device 200 may include a first SIM interface 202a, which may receive a first identity module SIM-1 204a that is associated with a first subscription. The multi-SIM communication device 200 may also include a second SIM interface 202b, which may receive a second identity module SIM-2 204b that is associated with a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the multi-SIM communication device, and thus need not be a separate or removable circuit, chip or card.

A SIM used in various embodiments may store user account information, an IMSI a set of SIM application toolkit (SAT) commands and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The multi-SIM communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory computer readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure.

The general purpose processor 206 and the memory 214 may each be coupled to at least one baseband modem processor 216. Each SIM in the multi-SIM communication device 200 (e.g., the SIM-1 202a and/or the SIM-2 202b) may be associated with a baseband-RF resource chain. A baseband-RF resource chain may include the baseband modem processor 216, which may perform baseband/modem functions for communications on at least one SIM, and may include one or more amplifiers and radios, referred to generally herein as RF resources (e.g., RF resource 218a and, optionally, RF resource 218b). In some embodiments, baseband-RF resource chains may share the baseband modem processor 216 (i.e., a single device that performs baseband/modem functions for all SIMs on the multi-SIM communication device). In other embodiments, each baseband-RF resource chain may include physically or logically separate baseband processors (e.g., BB1, BB2).

The RF resources 218a, 218b may each be transceivers that perform transmit/receive functions for the associated SIM of the multi-SIM communication device. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or, optionally, a second wireless antenna 220b). The RF resources 218a, 218b may also be coupled to the baseband modem processor 216.

In some embodiments, the general purpose processor 206, the memory 214, the baseband processor(s) 216, and the RF resources 218a, 218b may be included in the multi-SIM communication device 200 as a system-on-chip. In some embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the multi-SIM communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the multi-SIM communication device 200 to enable communication between them, as is known in the art.

In some embodiments (not shown), the multi-SIM communication device 200 may include, among other things, additional SIM cards, SIM interfaces, a plurality of RF resources associated with the additional SIM cards, and additional antennae for connecting to additional mobile networks.

The multi-SIM communication device 200 may optionally include an RF power management unit 230 configured to manage the power modes of the one or more RF resources 218a, 218b while the RF resources 218a, 218b are idle, such as between reception activities during one or more subscriptions' DRX cycles. In some embodiments, the RF power management unit 230 may determine whether to power down the RF resources 218a, 218b completely or to place the RF resources 218a, 218b in a low-power state that maintains their configuration register values as described in the disclosure. In some embodiments, the RF power management unit 230 may be implemented within the general purpose processor 206. In other embodiments, the RF power management unit 230 may be implemented as a separate (from the general purpose processor 206) hardware component. In yet other embodiments, the RF power management unit 230 may be implemented as a software application stored within the memory 214 and executed by the general purpose processor 206.

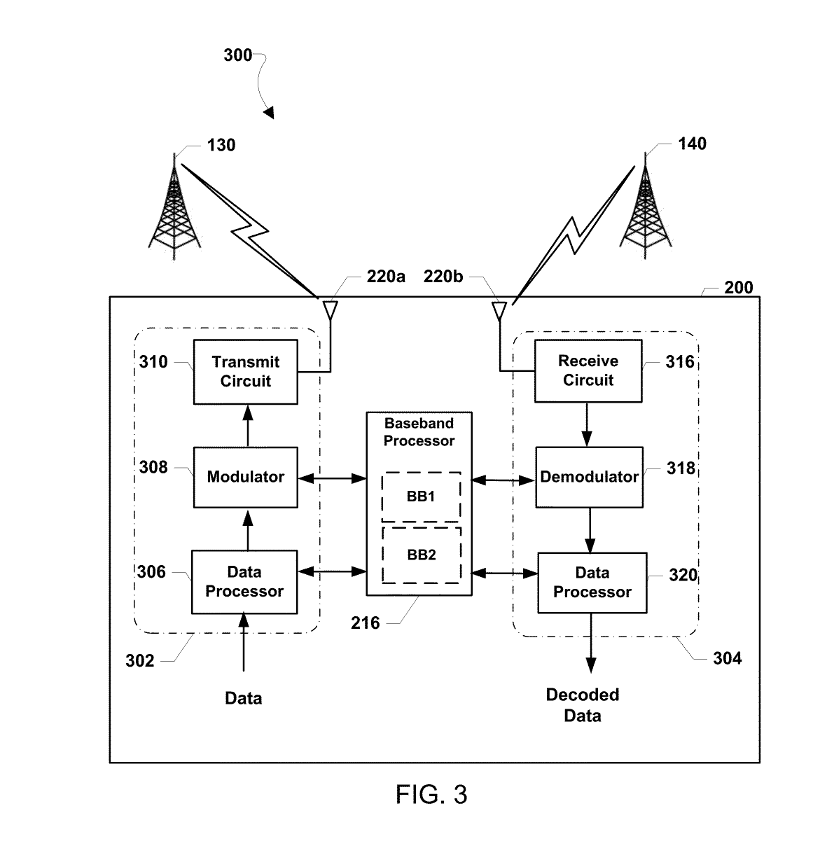

FIG. 3 illustrates a block diagram 300 of transmit and receive components in separate RF resources on a multi-SIM communication device 200, as described with reference to FIGS. 1-2 according to various embodiments. With reference to FIGS. 1-3, for example, a transmitter 302 may be part of the RF resource 218a, and a receiver 304 may be part of the RF resource 218b. In particular embodiments, the transmitter 302 may include a data processor 306 that may format, encode, and interleave data to be transmitted. The transmitter 302 may include a modulator 308 that modulates a carrier signal with encoded data, such as by performing Gaussian minimum shift keying (GMSK). One or more transmit circuits 310 may condition the modulated signal (e.g., by filtering, amplifying, and upconverting) to generate an RF modulated signal for transmission. The RF modulated signal may be transmitted, for example, to the first base station 130 via the first wireless antenna 220a.

At the receiver 304, the second wireless antenna 220b may receive RF modulated signals from the second base station 140. One or more receive circuits 316 may condition (e.g., filter, amplify, and downconvert) the received RF modulated signal, digitize the conditioned signal, and provide samples to a demodulator 318. The demodulator 318 may extract the original information-bearing signal from the modulated carrier wave, and may provide the demodulated signal to a data processor 320. The data processor 320 may de-interleave and decode the signal to obtain the original, decoded data, and may provide decoded data to other components in the multi-SIM communication device 200. Operations of the transmitter 302 and the receiver 304 may be controlled by a processor, such as the baseband processor(s) 216. In various embodiments, each of the transmitter 302 and the receiver 304 may be implemented as circuitry that may be separated from their corresponding receive and transmit circuitries (not shown). In other embodiments, the transmitter 302 and the receiver 304 may be respectively combined with corresponding receive circuitry and transmit circuitry (i.e., as transceivers associated with the SIM-1 204a and the SIM-2 204b).

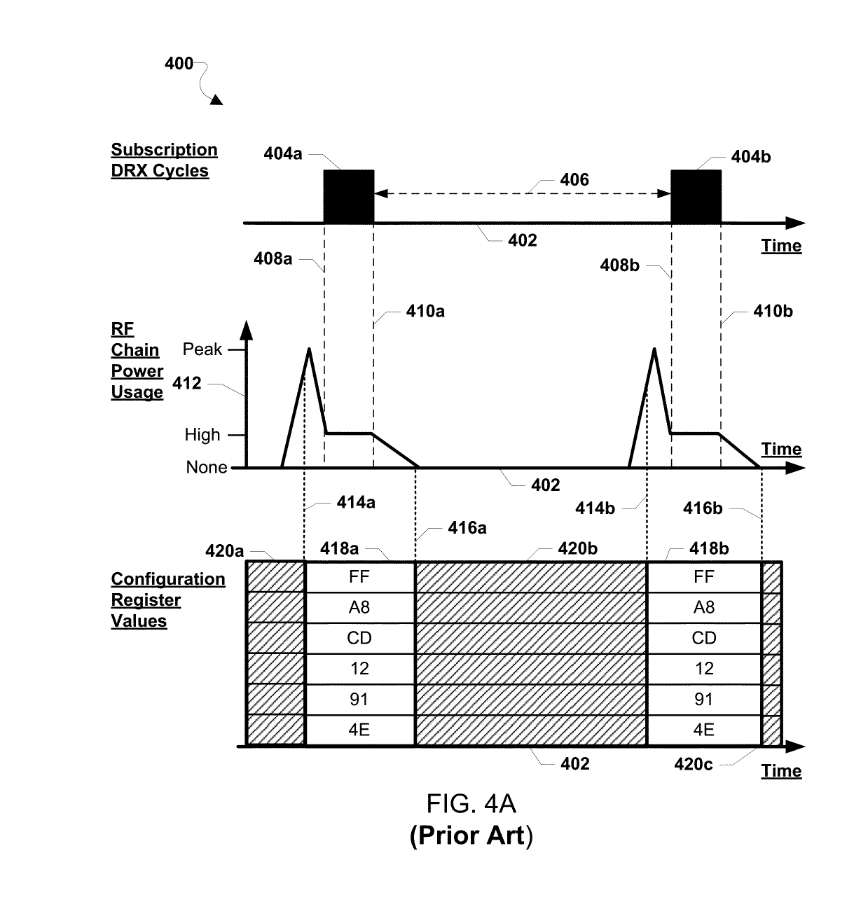

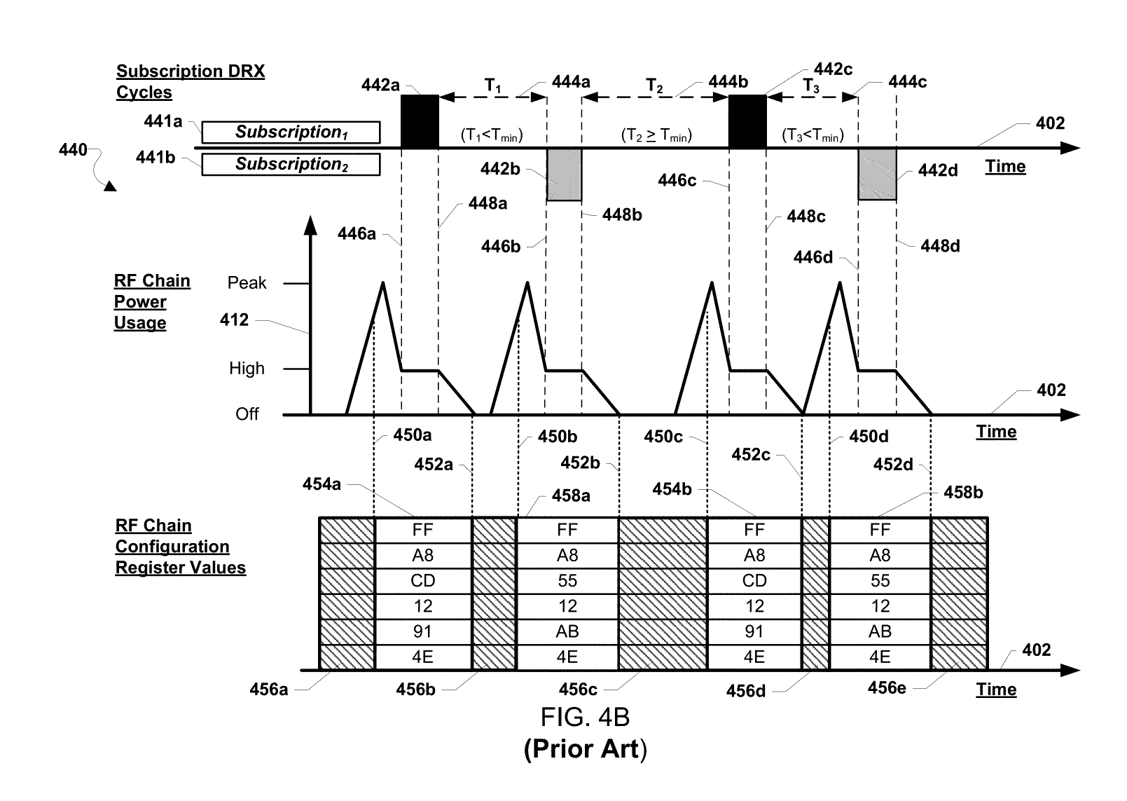

FIGS. 4A-4B illustrate timeline diagrams 400, 440 that show the effects over time 402 of always powering down a RF chain (e.g., the RF resources 218a, 218b in FIG. 2) between subscriptions' DRX activities according to techniques implemented on a conventional mobile communication device. Specifically, the timeline diagrams 400, 440 illustrate the interrelation of one or more subscriptions' reception activities, RF chains' power usage, and the status of the RF chains' configuration registers.

In the example illustrated in FIG. 4A, the RF chain services one subscription performing DRX activities, such as reception activities 404a, 404b, while in an idle-standby mode. The subscription's reception activities 404a begin at a start time 408a and end at a time 410a, and the subscription's reception activities 404b begin at a start time 408b and end at a time 410b. When the subscription is not performing reception activities, the RF chain is idle, such as during an idle period 406, which is the amount of time between the end of reception activities 404a (i.e., the end time 410a) and the beginning of the reception activities 404b (i.e., the start time 408b).

Prior to servicing the reception activities 404a, the RF chain is powered down at an earlier time (not shown) to use little or no power. As a result, the RF chain's configuration registers are powered down and any previously stored values are lost or corrupted so the registers will effectively store blank values 420a.

In order to service the reception activities 404a of the subscription, the RF chain begins performing warm-up operations before the start time 408a. As a result of powering up, the RF chain experiences an inrush of power needed to reactivate the RF chain's various components. The inrush of power is also required to reinitialize/rewrite the configuration registers at a time 414a to include “initialized” values 418a that enable the RF chain to service the reception activities 404a. As shown on the power usage axis 412, the inrush of power before the start time 408a of the reception activities 404a corresponds with an extreme or “peak” amount of power usage in comparison to the normal or “high” amount of power the RF chain uses to service the subscription during the reception activities 404a.

When the reception activities 404a end at the time 410a, the RF chain begins the process of powering down for the idle period 406 in order to save energy until the start time 408b of the next reception activities 404b, and the RF chain is fully powered down by a time 416a. Because the RF chain's configuration registers are fully powered down by the time 416a, the values 418a stored in the registers are lost, and the registers only include corrupt or blank values 420b until the RF chain powers up again.

The RF chain remains powered down until the reception activities 404b are scheduled to begin at the start time 408b. Shortly before the start time 408b, the RF chain again performs warm-up operations to power up its components and rewrite/reinitialize its configuration registers as described above. During these warm-up operations, as described, the RF chain experiences another power spike or peak power usage as shown on the power usage axis 412 due to the inrush of power needed to rewrite the configuration registers and to power up other RF chain components. As a result of the warm-up operations and updating the RF chain's configuration registers at a time 414b, the registers include values 418b that enable the RF chain to service the reception activities 404b.

When the reception activities 404b end at the time 410b, the RF chain is powered down again such that the values 418b stored in the RF chain's configuration registers are lost when the RF chain fully powers down at a time 416b. As a result, the configuration registers only include blank values 420c.

As the subscription's reception activities may be periodic based on its DRX cycle, the above operations may repeat as long as the subscription remains in an idle-standby mode.

Pursuant to conventional techniques, an RF chain is always powered down between reception activities in order to reduce the amount of power used while the RF chain is idle. However, because powering up an RF chain after powering the RF chain requires considerable power, powering down the RF chain may ultimately result in no net power savings when the RF chain's idle period is too short, which may be more likely to occur when the RF chain services multiple subscriptions.

FIG. 4B illustrates an example of conventional RF chain power management techniques implemented on a multi-SIM communication device, including an RF chain that supports two subscriptions with different DRX cycle lengths.

In the example illustrated in FIG. 4B, the RF chain services a first subscription 441a and a second subscription 441b over time 402. The first subscription 441a is scheduled to periodically perform reception activities (e.g., reception activities 442a, 442c), and the second subscription 441b is similarly scheduled to perform reception activities (e.g., reception activities 442b, 442d). The reception activities 442a-442d are scheduled to begin at times 446a-446d, respectively, and to end at times 448a-448d, respectively.

The RF chain powers up before the start time 446a of the reception activities 442a, and corrupt or blank values 456a stored in the RF chain's configuration registers are replaced at a time 450a with values 454a that enable the RF chain to service the reception activities 442a of the first subscription 441a. When the reception activities 442a end at the time 448a, the RF chain begins powering down, causing the configuration registers to lose the values 454a at a time 452a. Between the reception activities 442a, 442b, the RF chain is powered off for an idle period 444a (labeled in FIG. 4B as “T₁”).

The RF chain also begins powering up before the start time 446b of the reception activities 442b, and blank values 456b in the RF chain's configuration registers resulting from powering down the RF chain at the time 452a are replaced at a time 450b with values 458a that enable the RF chain to service the reception activities 442b of the second subscription 441b. When the reception activities 442b end at the time 448b, the RF chain begins powering down, causing the configuration registers to lose the initialized values 458a at a time 452b. Between the reception activities 442b, 442c, the RF chain is powered off for an idle period 444b (labeled in FIG. 4B as “T₂”), which is longer than the idle period 444a due to the different DRX cycles of the subscriptions 441a, 441b.

The RF chain again begins powering up before the start time 446c of the reception activities 442c. As part of the RF chain's warm-up operations, blank values 456c stored in the RF chain's configuration registers are replaced at a time 450c with values 454b that enable the RF chain to service the reception activities 442c of the first subscription 441a. When the reception activities 442c end at the time 448c, the RF chain begins powering down, causing the configuration registers to lose the initialized values 454b at a time 452c. Between reception activities 442c, 442d, the RF chain is powered off for an idle period 444c (labeled in FIG. 4B as “T₃”).

As illustrated in FIG. 4B, the idle period 444c is shorter than either of the idle periods 444a and 444b, requiring the RF chain to begin powering up in anticipation of the start time 446d almost as soon as the RF chain completely powers down, at the time 452c. In order to enable the RF chain to service the reception activities 442d, the blank values 456d in the RF chain's configuration registers resulting from powering down the RF chain at the time 452c are replaced at the time 450d with values 458b. When the reception activities 442b end at the time 448b, the RF chain begins powering down, causing the initialized values 458b stored in the RF chain's configuration registers to be replaced with blank values 456e at a time 452d.

As described (e.g., with reference to FIG. 4A), as the RF chain powers up before each of the reception activities 442a-442d, the RF chain experiences an inrush of power (i.e., depicted as “peak” power usage on the power usage axis 412) as a result of rewriting/reinitializing the RF chain's configuration registers and/or powering up other components of the RF chain that are powered off while the RF chain is idle. The inrush of power needed to power up the RF chain and rewrite/reinitialize the configuration registers is typically offset by the power saved while the RF chain is idle. However, as illustrated in FIG. 4B, the lengths of the DRX cycles of the first subscription 441a and the second subscription 441b are different, causing the idle period 444c to be shorter than the idle period 444a, which, in turn, is shorter than the idle period 444b. Because the amount of time the RF chain is idle between reception activities 442a-442d is directly related to the amount of power saved by powering off the RF chain, powering down during the idle periods 444a-444c will save different amounts of power.

Given the substantial inrush of power needed to power up the RF chain and reinitialize communication registers, powering down the RF chain between some reception activities may not always result in net power savings in situations in which the RF chain's idle time is less than a certain threshold amount of time (labeled in FIG. 4B as “Tₘᵢₙ”). As illustrated in FIG. 4B, powering down the RF chain during the idle period 444b results in net power savings because the idle period 444b exceeds (or equals) the minimum amount of time needed to achieve net power savings by powering down the RF chain (i.e., T₂≧Tₘᵢₙ). However, powering down the RF chain during the idle period 444a results in no net power savings because the idle period is less than the minimum amount of time the RF chain must be powered down to yield net power savings (i.e., T₁<Tₘᵢₙ). Similarly, the idle period 444c between the reception activities 442c and reception activities 442d is also too short to result in net power savings (i.e., T₃<Tₘᵢₙ).

Because powering down the RF chain between some reception activities may yield net power savings in some cases and not others, conventional methods of always powering down the RF chain after servicing reception activities are ineffective because they do not account for idle times that are too short to achieve net power savings and because they do not anticipate idle times of variable lengths.

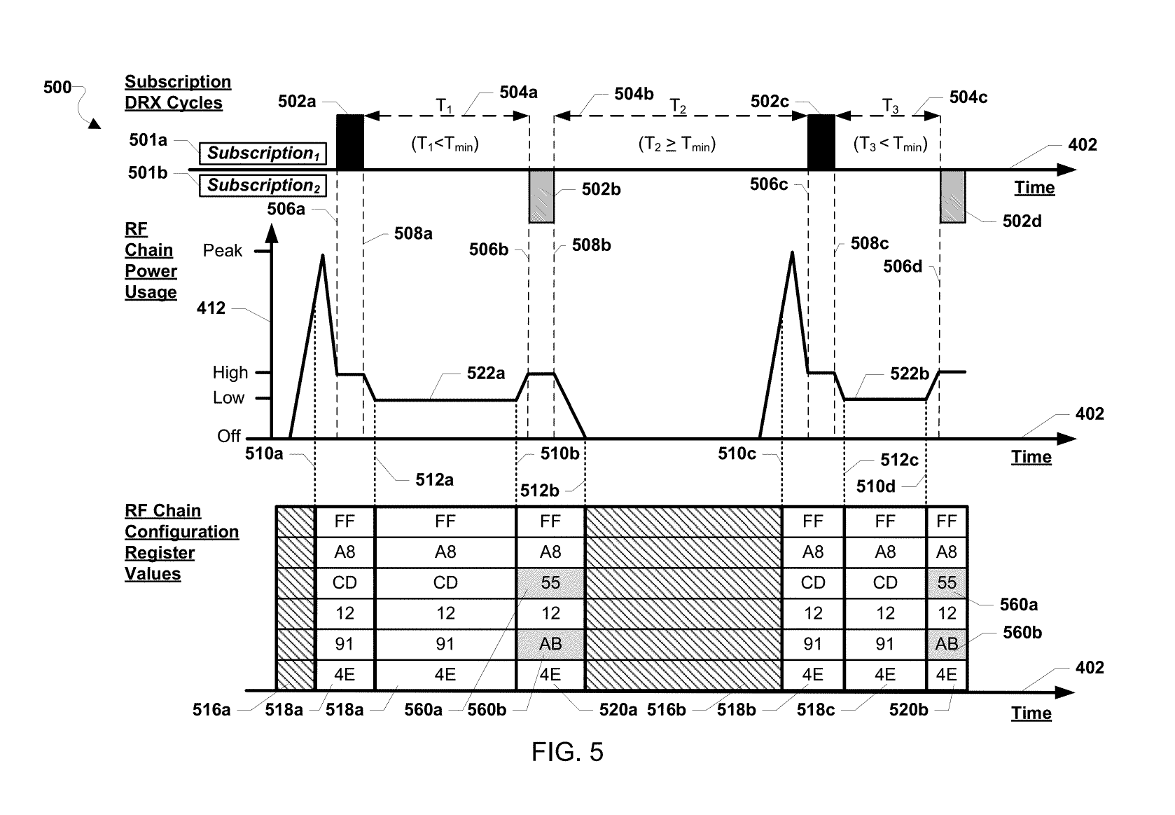

FIG. 5 illustrates timeline diagrams 500 showing the effects of dynamically managing power usage of an RF chain (e.g., RF resources 218a, 218b of FIG. 2) on a multi-SIM communication device (e.g., the multi-SIM communication device 200 of FIG. 2) based on the amount of time the RF chain is idle between reception activities according to various embodiments.

In the example illustrated in FIG. 5, the RF chain may service a first subscription 501a and a second subscription 501b that are both operating in an idle-standby mode. The first subscription 501a may periodically perform reception activities based on its DRX cycle (e.g., reception activities 502a, 502c), and the second subscription 501b may also periodically perform reception activities based on a different DRX cycle (e.g., reception activities 502b, 502d). In some embodiments, these DRX cycles may not overlap, reducing the amount of time between some reception activities.

After previously powering down (not shown), the RF chain may begin powering on before the reception activities 502a begins at a time 506a, causing a substantial inrush of power to occur (corresponding with the “peak” power usage as depicted on the power usage axis 412). At a time 510a, such as during the RF chain's warm-up operations, a device processor operating on the multi-SIM communication device may rewrite/reinitialize the RF chain's corrupt or blank values 516a stored in the RF chain's configuration registers so that the registers include values 518a that enable the RF chain to support the reception activities 502a of the first subscription 501a.

As described above (e.g., with reference to FIG. 4B), because the DRX cycle lengths of subscriptions may be different, powering down the RF chain between some reception activities may yield net power savings in some cases, depending on the length of time the RF chain will be idle between these reception activities. Thus, in some embodiments, in response to recognizing the end of reception activities, a processor executing on the multi-SIM communication device may determine whether the amount of time the RF chain will be idle between reception activities is less than a minimum time threshold (labeled in FIG. 5 as “Tₘᵢₙ”) in order to determine whether powering down the RF chain will result in net power savings.

In the example illustrated in FIG. 5, in response to determining that the reception activities 502a have ended at an end time 508a, the device processor may determine that the reception activities 502b are scheduled to begin at a start time 506b and may calculate an idle period 504a, such as by subtracting the end time 508a of the reception activities 502a from the start time 506b of the reception activities 502b. The device processor may compare the idle period 504a with the minimum time threshold and may determine that the idle period 504 does not exceed the threshold (i.e., T₁<Tₘᵢₙ), indicating that powering down the RF chain would not result in net power savings. As described, in some embodiments, the device processor may consider additional factors that may affect the usefulness of powering down the RF chain, such as whether there will enough time to power up the RF chain before upcoming reception activities (i.e., the RF chain's power-up latency).

In response to determining that the idle period 504a does not exceed the minimum time threshold, the device processor may place the RF chain in a low-power mode that retains the initialized values 518a stored in the RF chain's configuration registers. Specifically, when the RF chain enters the low-power mode at a time 512a, the values 518a included in the configuration registers may be retained throughout the RF chain's low-power period 522a.

In order to retain the values 518a stored in the configuration registers, the device processor may configure one or more power rails/power supplies connected to the configuration registers to operate during the low-power period 522a. These power rails/supplies may be connected to the RF chain's registers, as well as analog power supplies, input/output pads, switches, and diversity antennae.

Continuing with the example illustrated in FIG. 5, in anticipation of the reception activities 502b of the second subscription 501b beginning at a start time 506b, the device processor may place the RF chain in a high-power/normal operating mode. Because the values 518a stored in the configuration registers are not lost during the low-power period 522a, the device processor may update the retained values 518a to ensure that the registers include values 520a that enables the RF chain to service the second subscription 501b. As a result, the RF chain may quickly transition from the low-power mode to a high-power mode needed to service the reception activities 502b without experiencing a substantial inrush of or spike in power.

In some embodiments, the device processor may identify only those registers that need updating to service upcoming reception activities. For example, the device processor may identify only those configuration registers at a time 510b that require updating to enable the RF chain to service the reception activities 502b of the second subscription 501b. Based on this determination, the device processor may update only those registers without having to rewrite/reinitialize all of the configuration registers. In the example illustrated in FIG. 5, the device processor may identify the shaded registers 560a-560b as unique to servicing the reception activities 502b, and the device processor may update only those registers 560a-560b.

In response to determining that the reception activities 502b have ended at an end time 508b, the device processor may identify the start time 506c of the next reception activities 502c, calculate the RF chain's idle period 504b based on the end time 508b and the start time 506c, and determine whether the idle period 504b is less than the minimum time threshold as described above. In the example illustrated in FIG. 5, the device processor may determine that powering off the RF chain during the idle period 504b would result in net power savings because the idle period 504b exceeds (or equals) the minimum time threshold (i.e., T₂≧Tₘᵢₙ). The device processor may also cause the RF chain to begin powering down in the normal/standard way. As a result, once the RF chain has powered down completely at a time 512b, the values 520a stored in the configuration registers may be lost, blanked, and or corrupted as described above.

The RF chain may remain powered down until shortly before the reception activities 502c of the first subscription 501a are scheduled to begin at a start time 506c, and the device processor may cause the RF chain to enter a high-powered or normal mode to handle the reception activities 502c. Because the blank values 516b stored in the configuration registers are not useful as a result of powering the RF chain down at the time 512b, the device processor must rewrite all of the registers at a time 510c to include values 518b that enable the RF chain to support the reception activities 502c of the first subscription 501a at the start time 506c. As a result of powering up and reinitializing the RF chain and its configuration registers 518c, the RF chain may experience a peak power usage corresponding to a substantial inrush/spike in power. However, because the idle period 504b exceeds (or equals) the minimum time threshold, the power saved by powering down the RF chain during the idle period 504b may offset the extra power required to power up the RF chain.

In response to determining that the reception activities 502c of the first subscription 501a have ended at a time 508c, the device processor may repeat the operations described above to determine whether powering down the RF chain until the start time 506d of the reception activities 502d of the second subscription 501b (i.e., idle period 504c) would result in net power savings. As illustrated in FIG. 5, because the DRX cycles of the first subscription 501a and the second subscription 501b may be different, the idle period 504c may be less than both the idle period 504b and the idle period 504a, and the processor may determine that powering down the RF chain during the idle period 504c would also not produce net power savings because the idle period 504c is less than the minimum time threshold (i.e., T₃<Tₘᵢₙ). Thus, the device processor may place the RF chain in a low-power mode such that, once the RF chain enters the low-power mode at a time 512c, the values 518b stored in the configuration registers are retained throughout the low-power period 522b.

The device processor may cause the RF chain to enter a high-power/normal mode starting at a time 510d in anticipation of the reception activities 502d of the second subscription 501b. As described above, the device processor may not need to rewrite/reinitialize all of the initialized values 518b stored in the configuration registers because the values 518b may be retained during the low-power period 522b, thereby enabling the RF chain to avoid a substantial inrush of power when entering the high-power mode. Further, since the initialized values 518b stored in the configuration registers are retained, the device processor may selectively update only values stored in particular registers (e.g., registers 560a-560b) needed to support the reception activities 502d of the second subscription 501b, thereby reducing the time and power needed to configure the RF chain to support the reception activities 502d.

While the above descriptions relate to an RF chain servicing two (or more) subscriptions, in some embodiments, the RF chain may only service one dedicated subscription, such as when the RF chain operates on a DSDA communication device or on a single-SIM communication device. In such embodiments, while the dedicated (or only) subscription is in an idle-standby mode, the device processor may perform the operations similar to those operations described above to determine whether powering down the RF chain between the reception activities of the dedicated subscription would result in net powers savings. For example, various embodiments may be implemented on a mobile communication device that includes one SIM/subscription in order to reduce the RF chain's power usage when the subscription's DRX cycle is shorter than the minimum time threshold (i.e., Tₘᵢₙ). In such examples, the RF chain on these single-SIM communication devices may support one or more RATs (e.g., simultaneous GSM+LTE or simultaneous GSM+TD-SCDMA).

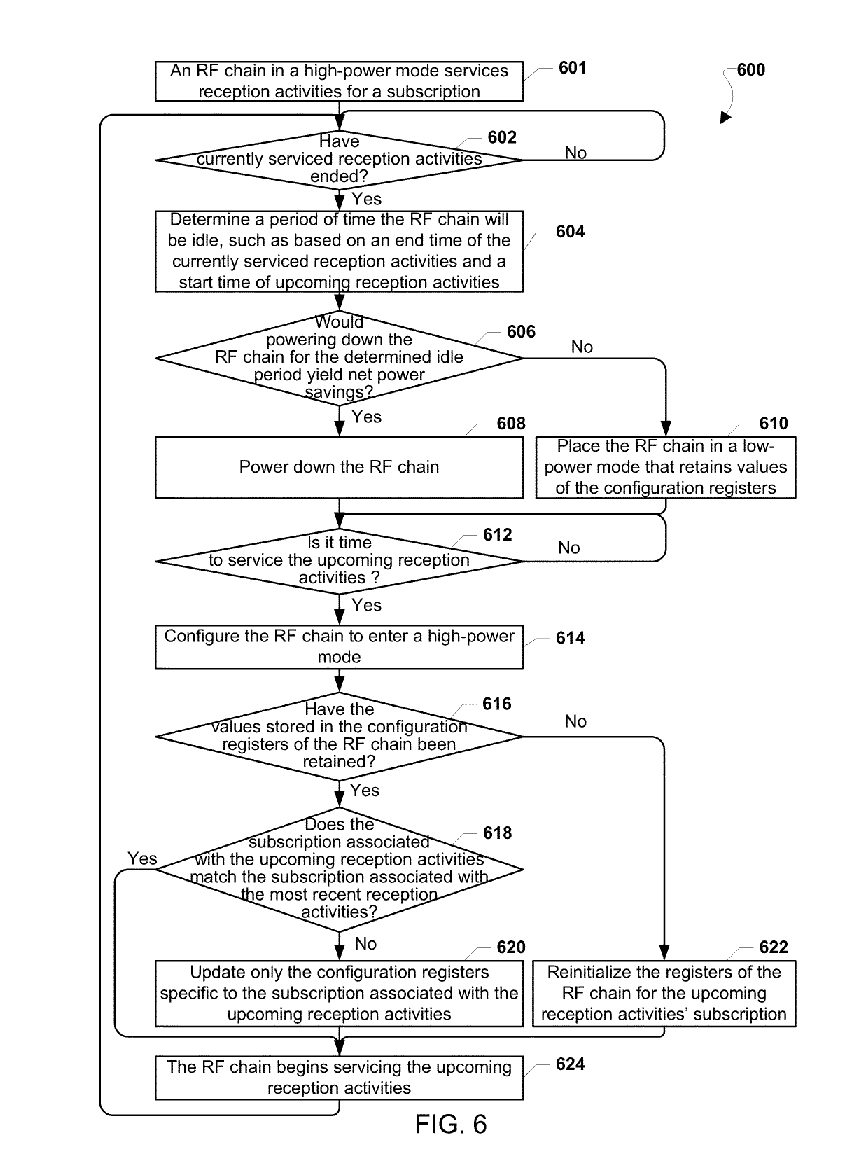

FIG. 6 illustrates a method 600 that may be implemented by a processor (e.g., the general purpose processor 206 of FIG. 2, the baseband modem processor 216, the RF power management unit 230, a separate controller, and/or the like) executing on a multi-SIM communication device (e.g., the multi-SIM communication device 200 of FIG. 2) that supports one or more subscriptions for implementing an RF chain power management strategy based on the amounts of time between reception activities. With reference to FIGS. 1-6, the device processor may begin performing the operations of method 600 in response to an RF chain, in a high-power mode, servicing reception activities of a subscription in block 601. For example, the RF chain may have previously powered up to service a subscription's reception activities (e.g., as described with reference to FIGS. 4A-5).

In determination block 602, the device processor may determine whether reception activities that the RF chain is currently servicing have ended, such as by monitoring for a scheduled end time for those reception activities. In response to determining that the reception activities have not ended (i.e., determination block 602=“No”), the device processor may repeat the operations in determination block 602 in a loop until the processor determines that the reception activities of the subscription have ended.

In response to determining that the reception activities of subscription have ended (i.e., determination block 602=“Yes”), the device processor may determine a period of time that the RF chain will be idle, in block 604, such as based on an end time of the currently serviced reception activities and a start time of upcoming reception activities. In some embodiments, the device processor may obtain information regarding the schedule of upcoming reception activities of one or more subscriptions that the RF chain services, for example, by requesting this information from the one or more subscriptions' respective networks, by analyzing previous patterns of reception activities occurring on the multi-SIM communication device, etc. Based on this scheduling information, the device processor may determine the start time for the reception activities scheduled to occur next and may compute the RF chain's idle period based on this determined next start time.

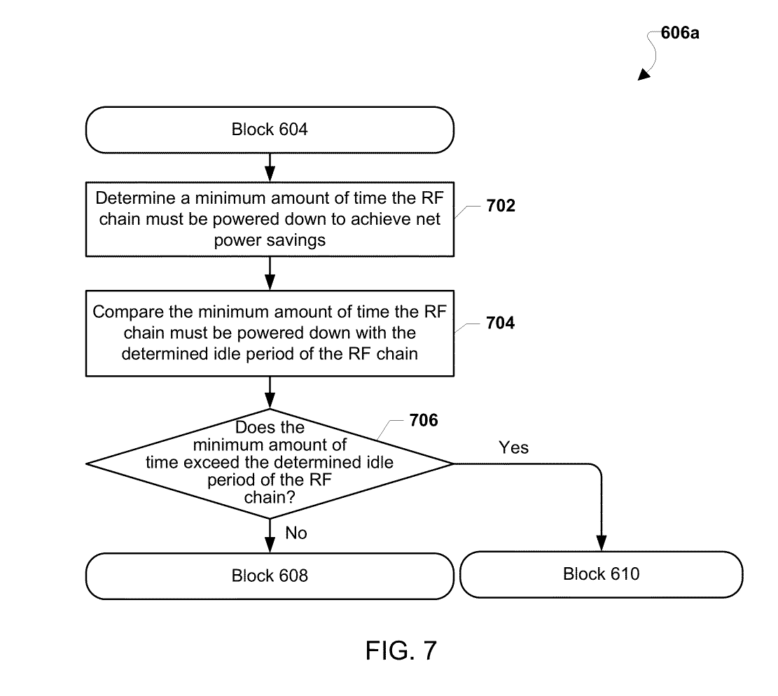

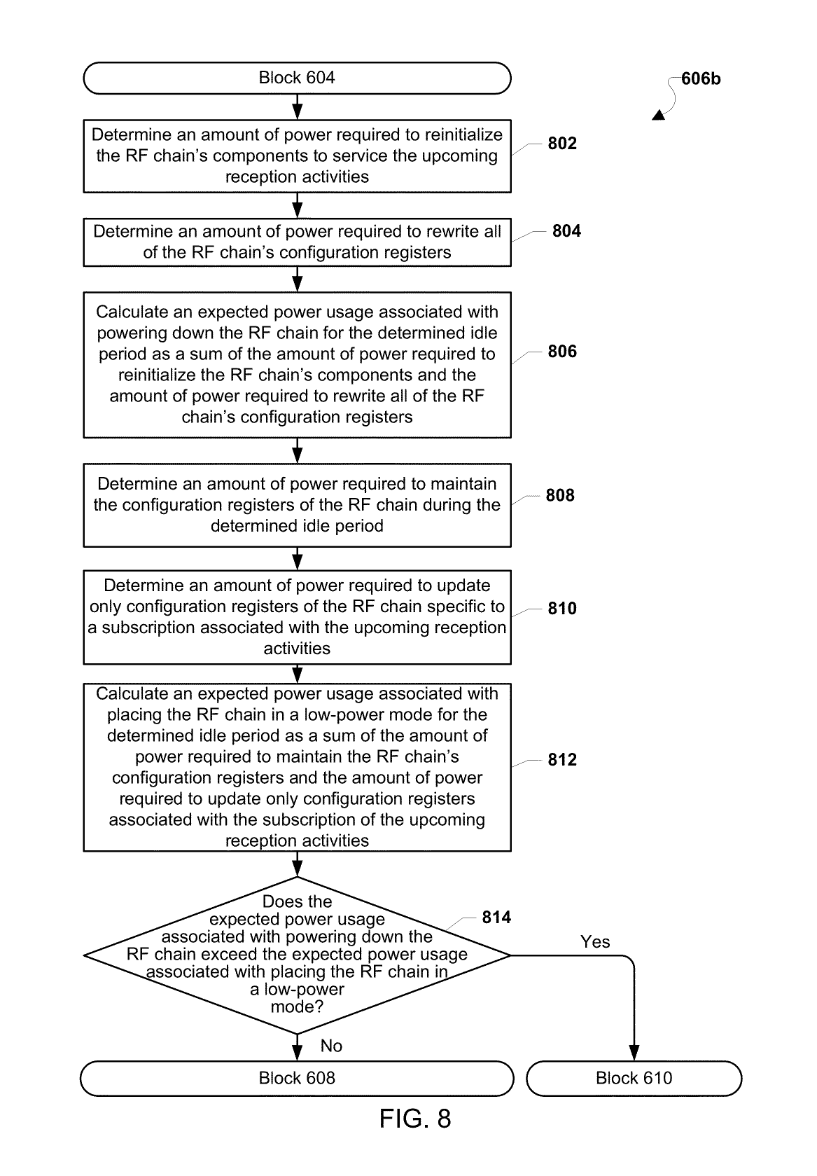

In determination block 606, the device processor may determine whether powering down the RF chain for the idle period determined in block 604 would yield net power savings. In some embodiments, (e.g., as described with reference to FIG. 7), the device processor may compare the RF chain's expected idle period determined in block 604 with a minimum time threshold (e.g., Tₘᵢₙ) to determine whether the minimum time threshold does not exceed the duration of the RF chain's expected idle period exceeds, thereby indicating that powering down the RF chain would result in net power savings. In other embodiments, the device processor may explicitly compare the expected power usage associated with powering the RF chain down entirely with the expected power usage associated with retaining the registers of the RF chain in a low-power mode and may make the determination in block 606 based on this comparison (e.g., as described with reference to FIG. 8). In some embodiments, as part of determination block 606, the device processor may compare the RF chain's expected idle period determined in block 604 with the RF chain power-up latency value to determine whether there will be enough time to accommodate the power-down/power-up cycle even in the low-power mode.

In response to determining that powering down the RF chain for the idle period determined in block 604 would not yield net power savings (i.e., determination block 606=“No”), and in some embodiments determining that the idle period will exceed the RF chain power-up latency value, the device processor may place the RF chain in a low-power mode that retains the values stored in the RF chain's configuration registers in block 610. In some embodiments of the operations of block 610, the device processor may implement the low-power mode by selectively deactivate/power down various components of the RF chain while ensuring that the power rails connected to the configuration registers remain activated. For example, the device processor may ensure that the low-dropout (“LDO”) regulators associated with the RF chains registers, analog power supplies, input/output pads, switches, and diversity antennae remain active while the RF chain operates in a low-power mode.

By placing the RF chain in a low-power mode, the device processor may ensure that the RF chain does not experience a substantial inrush of power to the registers when powering up to service the upcoming reception activities because the values of the RF chain's configuration registers are maintained and therefore do not need to be rewritten/reinitialize, reducing the overall amount of time and power required to power up the RF chain.

In response to determining that powering down the RF chain for the amount of time determined in block 604 would yield net power savings (i.e., determination block 606=“Yes”), the device processor may power down the RF chain in block 608 using conventional methods. For example, the power rails connected to the RF chain's configuration registers may be de-energized, thereby resulting in the loss of the value stored in those registers.

In response to either powering down the RF chain in block 608 or placing the RF chain in a low-power mode to retain the values stored in its configuration registers in block 610, the device processor may determine whether it is time to service the upcoming reception activities in determination block 612, such as by monitoring for a wakeup or start time of the upcoming reception activities. In response to determining that it is not time to service the upcoming reception activities (i.e., determination block 612=“No”), the device processor may repeat the operations in determination block 612 until the processor determines that it is time to service the upcoming reception activities. In other words, the RF chain may remain powered down or in a low-power mode until it is time for the RF chain to service the upcoming reception activities.

In response to determining that it is time to service the upcoming reception activities (i.e., determination block 612=“Yes”), the device processor may configure the RF chain to enter a high-power mode in block 614. In the event that the RF chain has been powered down completely in the block 608, the RF chain's components, such as configuration registers, capacitors, transceivers, antenna, etc., may be powered on and/or reinitialized in order to provide service for the current reception activities. Alternatively, in the event that the RF chain has been placed in a low-power mode in block 610, the device processor may configure the RF chain's components to resume a high-power mode from the low-power mode without needing to reinitialize/rewrite the values stored in the RF chain's configuration registers.

In determination block 616, the device processor may determine whether the values stored in the configuration registers of the RF chain have been retained, such as by checking the RF chains configuration registers for lost or corrupted values that may occur as a result of powering down the RF chain in block 608. In some embodiments, the device processor may check a flag, bit, or other mechanism that indicates whether the RF chain was powered down completely in block 608 or placed in the low-power mode in block 610.

In response to determining that the values stored in the configuration registers of the RF chain have not been retained (i.e., determination block 616=“No”), the device processor may reinitialize the configuration registers RF chain for the subscription associated with the upcoming reception activities in block 622. In some embodiments, the device processor may completely rewrite/reinitialize the values stored in the RF chain's configuration registers as the values previously stored in the registers may have been lost as a result of powering down the RF chain in block 608.

In response to determining that the value stored in the configuration registers RF chain have been retained (i.e., determination block 616=“Yes”), the device processor may determine whether the subscription associated with the upcoming reception activities matches the subscription associated with the reception activities that occurred most recently in determination block 618. In some embodiments, the subscription associated with the upcoming reception activities may be the same subscription as the subscription performing the most recent reception activities (e.g., on a single-SIM communication device), or the subscription may be a different subscription when the RF chain services more than one subscription (e.g., as described above with reference to FIGS. 4B and 5). Thus, the device processor may need to determine whether one or more configuration register values the RF chain used to service the most recent reception activities need to be updated in order to enable the RF chain to service the subscription associated with the upcoming reception activities.

In response to determining that the subscription associated with the upcoming reception activities is not the same as the subscription associated with the most recent reception activities (i.e., determination block 618=“No”), the device processor may update only the configuration registers specific to the subscription associated with the upcoming reception activities in block 620. As described (e.g., with reference to FIG. 5), the device processor may leverage the fact that the values in the RF chain's configuration registers are retained during the RF chain's low-power period by updating only those registers that need to be changed to service the subscription associated with the upcoming reception activities. This avoids the need to rewrite/reinitialize each of the RF chain's configuration registers, thus reducing the amount of time and power needed to enable the RF chain to service the current reception activities.

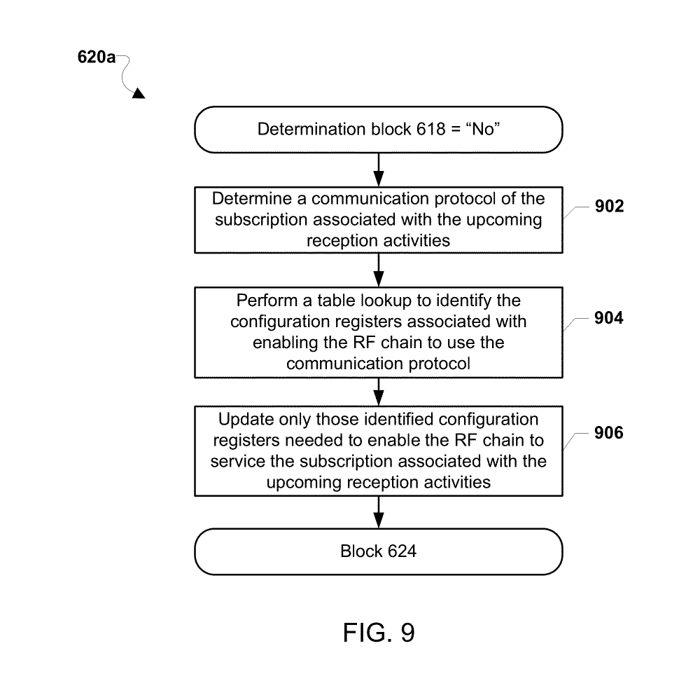

In some embodiments of the operations performed in block 620 the device processor may compare register values needed to support the upcoming reception activities with the register values retained during the low-power period. In such an embodiment, the device processor may only rewrite a register in response to determining a difference between the register value associated with the upcoming reception activities and the retained register value. In some embodiments, the device processor may perform a lookup table to identify specific registers that must be updated to enable the RF chain to service the upcoming reception activities (e.g., as described with reference to FIG. 9).

In response to determining that the subscription associated with the upcoming reception activities matches the subscription associated with the most recent reception activities (i.e., determination block 618=“Yes”), the RF chain may begin servicing the upcoming reception activities in block 624 without updating the values stored in the RF chain's configuration registers. In other words, because the subscription associated with the upcoming reception activities is the same as the subscription associated with the most recent reception activities, the RF chain's configuration registers may already be configured to service that subscription.

Alternatively, in response to the device processor's updating only the configuration registers specific to the subscription associated with the upcoming reception activities in block 620 or the processor's reinitializing all of the RF chain's configuration registers in block 622, the RF chain may begin servicing the upcoming receptions in block 624.

The device processor may repeat the above operations in determination block 602 of the method 600 by determining whether the reception activities currently serviced by the RF chain in block 624 have ended.

As described, in some embodiments of the operations performed in determination block 606 (not shown), the device processor may account for the time needed to power up the RF chain (i.e., the RF chain's power-up latency). As described, the device processor may determine that there is not enough time to power down and to power up the RF chain before the start time of the upcoming reception activities (e.g., when the idle period determined in block 604 is very short), and in response, the device processor may not power down the RF chain. Similarly, the device processor may determine whether there is enough time to power up the RF chain from the low-power mode that retains the RF chain's register values. Because powering up the RF chain from the low-power mode may take less time because fewer registers must be rewritten during the RF chain's warm-up operations, there may be enough time to place the RF chain in the low-power mode even though there may not be enough time to power down the RF chain completely. Further, in response to determining that there is not enough time to place the RF chain in a low-power mode, the device processor may keep the RF chain operating in a high-power mode through the upcoming reception activities.

While the above embodiments are described with reference to an amount of time that the RF chain is expected to be idle between a subscription's DRX reception activities, in some embodiments, the device processor may perform similar operations as those described with reference to the method 600 in other situations in which the RF chain may not be performing reception or transmission activities for a certain period of time. Thus, in some embodiments, the device processor may determine whether to power down the RF chain or to place the RF chain in a low-power mode that retains its register values in any situation in which the RF chain may not be transmitting or receiving for a determined period of time. In particular, in some embodiments of the operations performed in the method 600, the device processor may determine a period of time that the RF chain will not be transmitting or receiving, in block 604, and the device processor may determine whether powering down the RF chain for the determined period of time that the RF chain will not be transmitting or receiving would yield net power savings, in determination block 606. In such embodiments, in response to determining that powering down the RF chain for the determined period of time that the RF chain will not be transmitting or receiving would not yield net power savings, the device processor may place the RF chain in a low-power mode that retains its register values, in block 610, and may power down the RF chain in response to determining that powering down the RF chain for the determined period of time would yield net power savings, in block 608.

FIG. 7 illustrates a method 606a that may be implemented by a processor (e.g., the general purpose processor 206 of FIG. 2, the baseband modem processor 216, the RF power management unit 230, a separate controller, and/or the like) on a multi-SIM communication device (e.g., the multi-SIM communication device 200 of FIG. 2) for determining whether powering down the an RF chain between reception activities would result in net power savings. The operations of method 606a implement embodiments of the operations of determination block 606 of the method 600 described above with reference to FIG. 6. Thus, with reference to FIGS. 1-7, the device processor may begin performing the operations of the method 606a in response to determining a period of time that the RF chain will be idle in block 604 of the method 600.

As described (e.g., with reference to FIGS. 4B and 5), powering down an RF chain may reduce the overall power usage of the multi-SIM communication device in situations in which the RF chain is idle between reception activities for a long enough period of time to offset the energy required to power up the RF chain, such as the substantial inrush of power needed to power up the RF chain's components and rewrite/reinitialize the RF chain's configuration registers. Thus, in some embodiments, the device processor may determine whether powering down the RF chain will result in net power savings based on the expected length of time the RF chain will idle.

In block 702, the device processor may determine a minimum amount of time the RF chain must be powered down to obtain net power savings (e.g., Tₘᵢₙ as described above with reference to FIG. 5). In some embodiments, the device processor may calculate the minimum time threshold. For example, the device processor may receive information related to the amount of power historically needed to power up the RF chain, such as from a power meter (not shown) operating on the multi-SIM communication device. The device processor may similarly calculate how much power is saved per unit of time by powering down the RF chain. Based on this information, the device processor may determine the minimum amount of time the RF chain must be powered down to achieve net power savings.

In other embodiments, rather than calculating the minimum time threshold locally on the multi-SIM communication device, the device processor may receive the minimum time threshold from a server device via a network connection, from a user input, and/or as a value an original-equipment manufacturer has included on the multi-SIM communication device.

In block 704, the device processor may compare the minimum amount of time the RF chain must be powered down as determined in block 702 with the idle period of the RF chain as determined in block 604. Based on this comparison, the device processor may determine whether the minimum amount of time the RF chain must be powered down to obtain net power savings exceeds the determined idle period of the RF chain in determination block 706.

In response to determining that the minimum amount of time determined in block 702 does not exceeds the idle period determined in block 604 (i.e., determination block 706=“No”), the device processor may continue performing operations in block 608 of the method 600 by powering down the RF chain to achieve net power savings.

In response to determining that the minimum amount of time determined in block 702 exceeds the amount of time the RF chain will be idle as determined in block 604 (i.e., determination block 706=“Yes”), the device processor may continue performing the operations in block 610 of the method 600 by placing the RF chain in a low-power mode that retains the values stored in the RF chain's configuration registers. As described, the device processor may place the RF chain in a low-power mode in response to determining that powering down the RF chain will not result in net power savings because powering up the RF chain will require more power than the power saved while the RF chain is powered down.

FIG. 8 illustrates a method 606b that may be implemented by a processor (e.g., the general purpose processor 206 of FIG. 2, the baseband modem processor 216, the RF power management unit 230, a separate controller, and/or the like) executing on a multi-SIM communication device (e.g., the multi-SIM communication device 200 of FIG. 2) for determining whether powering down an RF chain between reception activities will result in net power savings based on a comparison of the expected power use of powering up the RF chain and the expected power use of placing the RF chain in a low-power mode. The operations of method 606b implement some embodiments of the operations of determination block 606 of the method 600 described above with reference to FIG. 6. With reference to FIGS. 1-8, the device processor may begin performing the operations of the method 606b in response to determining an idle period of the RF chain in block 604 of the method 600.

As described (e.g., with reference to FIG. 6), the device processor may determine whether to power down the RF chain by determining whether the power saved from powering down the RF chain exceeds or equals the power required to power up the RF chain, such as the power inrush associated with rewriting/reinitializing all of the RF chain's configuration registers. However, it may be the case that, while powering down the RF chain may produce net power savings, placing the RF chain in a low-power mode that retains the RF chain's configuration register values may offer even more power savings than powering down the RF chain. Thus, in some embodiments, rather than utilizing a minimum time threshold to determine whether to power down the RF chain, the device processor may determine whether to power down the RF chain based on a comparison of the expected power usage associated with powering down the RF chain and the expected power usage associated with placing the RF chain in a low-power mode that retains the values in the RF chain's configuration registers.

In block 802, the device processor may determine an amount of power required to reinitialize the RF chain's components to service the upcoming reception activities. For example, the device processor may receive or generate information related to the power needed to power up the RF chain, such as the power required to charge the RF chain's capacitors. The device processor may similarly determine an amount of power required to rewrite/reinitialize all of the RF chain's configuration registers to service the upcoming reception activities in block 804. In some embodiments, the power required to rewrite/reinitialize the RF chain's configuration registers may account for the time and power needed to zero/clear the registers of spurious data produced as a result of powering down the RF chain, as well as the time and power needed to rewrite all of the registers to enable the RF chain to service the subscription associated with the upcoming reception activities.

In block 806, the device processor may calculate an expected power usage associated with powering down the RF chain as a sum of the amount of power required to reinitialize the RF chain's components as determined in block 802 and the amount of power required to rewrite all of the RF chain's configuration registers as determined in block 804. In other words, the expected power usage associated with powering down the RF chain may represent the total power required to power up the RF chain to service the upcoming reception activities.

In block 808, the device processor may determine an amount of power required to maintain the RF chain's configuration registers during the idle period determine in block 604. In some embodiments, the power determined in block 808 may account for the power required to power various components needed to maintain the configuration registers in a low-power mode, such as LDOs regulators/power rails, analog power supplies, input/output pads, switches, and diversity antennae. In some embodiments, the amount of power determined in block 808 may also reflect the RF chain's power usage while resuming a high-power mode in anticipation of servicing the upcoming reception activities.

In block 810, the device processor may determine an amount of power required to update only configuration registers of the RF chain that are specific to a subscription associated with the upcoming reception activities. In other words, because the values stored in the RF chain's configuration registers are retained as a result of placing the RF chain in a specialized low-power mode for that purpose, the device processor may only be required to make slight updates to the registers to configure the RF chain to support the upcoming reception activities. For example, in the event that the subscription associated with the most recent reception activities is also associated with the upcoming reception activities, which may occur when the RF chain only services one subscription, the device processor may not need to spend any time or power updating registers. In another example in which the subscription associated with the upcoming reception activities (e.g., a GSM subscription) is different than the last subscription (e.g., a WCDMA subscription), the device processor may only need to spend a small amount of time and power updating relatively few registers.

In block 812, the device processor may calculate an expected power usage associated with placing the RF in a low-power mode for the determined idle period as a sum of the amount of power required to maintain the RF chain's configuration registers in a low-power mode as determined in block 808 and the amount of power required to update only configuration registers associated with the subscription of the upcoming reception activities as determined in block 810. In other words, the device processor may calculate the total power required retains the values stored in the RF chain's configuration registers in a low-power mode and the amount of power required to prepare the RF chain to service the upcoming reception activities while in the low-power mode.

In determination block 814, the device processor may determine whether the expected power usage associated with powering down the RF chain as calculated in block 806 exceeds the expected power usage associated with placing the RF chain in a low-power mode as calculated in block 812. In response to determining that the expected power usage associated with powering down the RF chain exceeds the expected power usage associated with placing the RF chain in a low-power mode to maintain the RF chain's configuration register values (i.e., determination block 814=“Yes”), the device processor may continue performing operations in block 610 of the method 600 by placing the RF chain in a low-power mode that retains the values of the RF chain's configuration registers.

In response to determining that the expected power usage associated with powering down the RF chain does not exceed the expected power usage associated with placing the RF chain in a low-power mode to maintain the RF chain's configuration register values (i.e., determination block 814=“No”), the device processor may continue performing operations in block 608 of the method 600 by powering down the RF chain.

FIG. 9 illustrates a method 620a that may be implemented by a processor (e.g., the general purpose processor 206 of FIG. 2, the baseband modem processor 216, the RF power management unit 230, a separate controller, and/or the like) executing on a multi-SIM communication device (e.g., the multi-SIM communication device 200 of FIG. 2) for selectively updating values in an RF chain's configuration registers based on the communication protocol of the subscription associated with upcoming reception activities. The operations of the method 620a may implement embodiments of the operations of block 620 of the method 600 (e.g., as described above with reference to FIG. 6). Thus, with reference to FIGS. 1-9, the device processor may begin performing the operations of the method 620a in response to determining that the subscription associated with the upcoming reception activities is different than the subscription associated with the most recent reception activities (i.e., determination block 618=“No”).

As described, the RF chain may be placed in a low-power mode that retains the values stored in the RF chain's configuration registers that enabled the RF chain to service the subscription associated with the most recent reception activities (e.g., a GSM subscription). In response to determining that the subscription associated with the upcoming reception activities (e.g., a WCDMA subscription) is different than the most recent subscription, the device processor may need to update the RF chain's configuration registers to enable the RF chain to service the upcoming reception activities. However, the device processor may leverage the valid data that is already stored in the RF chain's registers to reduce the number of registers that may be required to be updated/rewritten in order to service the subscription associated with the upcoming reception activities.

In block 902, the device processor may determine a communication protocol of the subscription associated with the upcoming reception activities, such as by requesting information from the subscription regarding the subscription's radio access technology and/or the subscription's network type. For example, the device processor may obtain information from the subscription associated with the upcoming reception activities indicating that the subscription uses a GSM communication protocol to communicate with a GSM network.

In block 904, the device processor may perform a table lookup to identify the configuration registers associated with enabling the RF chain to use the communication protocol determined in block 902. In some embodiments, the device processor may reference a lookup table that includes information indicating the one or more configuration registers tailored to each of various communication protocols. For example, the lookup table may indicate that a certain number of registers must include particular values specific to a WCDMA communication protocol in order to enable the RF chain to support those WCDMA communications. The table may be implemented in memory (e.g., the memory 214), as a data table within a database, a stored spreadsheet, a collection of application or system variables, or any other data structure capable of being stored, ordered, and/or modified on the multi-SIM communication device.

In block 906, the device processor may update only those configuration registers identified in block 904 that are needed to enable the RF chain to service the subscription associated with the upcoming reception activities. In some embodiments, the number of registers associated with the determined communication protocol may be relatively few in comparison to the total number of configuration registers. In such embodiments, the device processor may only need to update a relatively few number of register updates to configure the RF chain to support the upcoming reception activities. Thus, by selectively updating only those register values associated with the determined communication protocol, the device processor may spend relatively little time and power enabling the RF chain to service the upcoming reception activities in contrast to the comparatively high amount of time and power the device processor would need to rewrite all of the RF chain's configuration registers.

By updating the RF chain's configuration registers to support the upcoming reception activities, the device processor may enable the RF chain to begin servicing the upcoming reception activities in block 624 of the method 600.

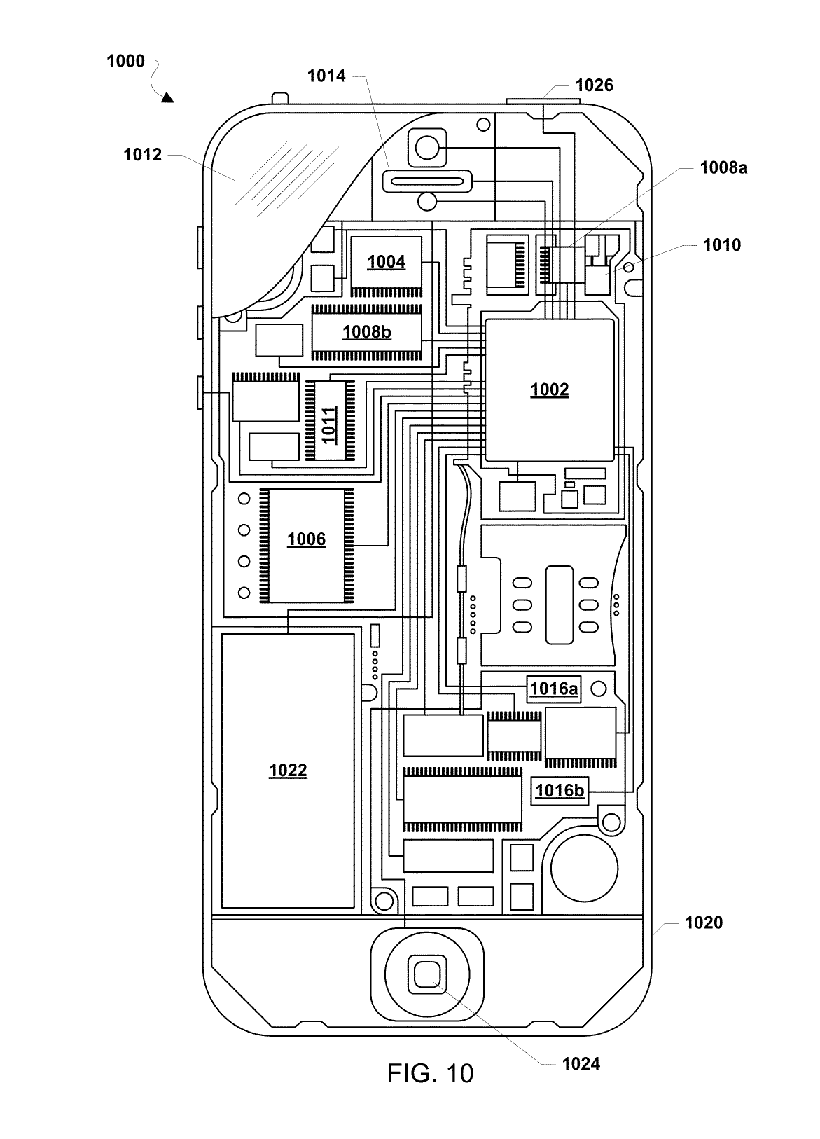

Various embodiments may be implemented in any of a variety of multi-SIM communication devices, an example of which (e.g., multi-SIM communication device 1000) is illustrated in FIG. 10. According to various embodiments, the multi-SIM communication device 1000 may be similar to the multi-SIM communication devices 110, 120, 200 as described above with reference to FIGS. 1-3. As such, the multi-SIM communication device 1000 may implement the methods 600, 606a, 606b, 620a of FIGS. 6-9.

The multi-SIM communication device 1000 may include a processor 1002 coupled to a touchscreen controller 1004 and an internal memory 1006. The processor 1002 may be one or more multi-core integrated circuits designated for general or specific processing tasks. The internal memory 1006 may be volatile or non-volatile memory, and may also be secure and/or encrypted memory, or unsecure and/or unencrypted memory, or any combination thereof. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the multi-SIM communication device 1000 need not have touch screen capability.

The multi-SIM communication device 1000 may have one or more cellular network transceivers 1008a, 1008b coupled to the processor 1002 and to two or more antennae 1010, 1011 and configured for sending and receiving cellular communications. The transceivers 1008a, 1008b and antennae 1010, 1011 may be used with the above-mentioned circuitry to implement the various embodiment methods. The multi-SIM communication device 1000 may include two or more SIM cards 1016a, 1016b coupled to the transceivers 1008a, 1008b and/or the processor 1002 and configured as described above. The multi-SIM communication device 1000 may include a cellular network wireless modem chip that enables communication via a cellular network and is coupled to the processor.

The multi-SIM communication device 1000 may also include speakers 1014 for providing audio outputs. The multi-SIM communication device 1000 may also include a housing 1020, constructed of a plastic, metal, or a combination of materials, for containing all or some of the components discussed herein. The multi-SIM communication device 1000 may include a power source 1022 coupled to the processor 1002, such as a disposable or rechargeable battery. The rechargeable battery may also be coupled to the peripheral device connection port to receive a charging current from a source external to the multi-SIM communication device 1000. The multi-SIM communication device 1000 may also include a physical button 1024 for receiving user inputs. The multi-SIM communication device 1000 may also include a power button 1026 for turning the multi-SIM communication device 1000 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method implemented on a mobile communication device for dynamically managing power usage of a radio-frequency (RF) chain, comprising:
determining a period of time that the RF chain will not be transmitting or receiving;
determining whether powering down the RF chain for the determined period of time would yield net power savings;
placing the RF chain in a low-power mode that retains values stored in configuration registers of the RF chain in response to determining that powering down the RF chain for the determined period of time would not yield net power savings; and
powering down the RF chain in response to determining that powering down the RF chain for the determined period of time would yield net power savings.

2. The method of claim 1, wherein values stored in the configuration registers of the RF chain are not retained when the RF chain is powered down.

3. The method of claim 1, wherein when the RF chain is powered down the RF chain is in a state that draws less power than when the RF chain is in the low-power mode.

4. The method of claim 1, wherein determining whether powering down the RF chain for the determined period of time would yield net power savings further comprises determining whether powering down the RF chain for the determined period of time would yield net power savings based on a period of time required to power up the RF chain.

5. The method of claim 1, wherein the mobile communication device is a multi-Subscriber-Identity-Module (multi-SIM) communication device comprising at least one subscription and at least one RF chain.

6. The method of claim 1, wherein determining a period of time that the RF chain will not be transmitting or receiving comprises determining a period of time the RF chain will be idle based on an end time of currently serviced reception activities and a start time of upcoming reception activities.

7. The method of claim 1, wherein:
determining whether powering down the RF chain for the determined period of time would yield net power savings comprises:
determining a minimum amount of time that the RF chain must be powered down to achieve net power savings; and
determining whether the minimum amount of time exceeds the determined period of time; and
placing the RF chain in a low-power mode that retains values stored in configuration registers of the RF chain comprises placing the RF chain in the low-power mode in response to determining that the minimum amount of time exceeds the determined period of time.

8. The method of claim 1, further comprising:
determining whether a subscription associated with upcoming reception activities matches a subscription associated with reception activities the RF chain serviced most recently; and
updating only those configuration registers of the RF chain that are specific to the subscription associated with the upcoming reception activities in response to determining that the subscription associated with the upcoming reception activities does not match the subscription associated with the reception activities the RF chain serviced most recently.

9. The method of claim 8, wherein updating only configuration registers specific to the subscription associated with the upcoming reception activities comprises:
determining a communication protocol of the subscription associated with the upcoming reception activities;
performing a table lookup to identify configuration registers of the RF chain associated with enabling the RF chain to use the communication protocol; and
updating only the identified configuration registers to enable the RF chain to service the subscription associated with the upcoming reception activities.

10. The method of claim 1, wherein:
determining whether powering down the RF chain for the determined period of time would yield net power savings comprises:
calculating an expected power usage associated with powering down the RF chain for the determined period of time;
calculating an expected power usage associated with placing the RF chain in the low-power mode for the determined period of time; and
determining whether the expected power usage associated with powering down the RF chain exceeds the expected power usage associated with placing the RF chain in the low-power mode; and
placing the RF chain in a low-power mode that retains values stored in configuration registers of the RF chain comprises placing the RF chain in the low-power mode in response to determining that the expected power usage associated with powering down the RF chain exceeds the expected power usage associated with placing the RF chain in the low-power mode.

11. The method of claim 10, wherein calculating an expected power usage associated with powering down the RF chain for the determined period of time comprises:
determining an amount of power required to reinitialize components of the RF chain that would be powered down during the determined period of time;
determining an amount of power required to rewrite all the configuration registers of the RF chain; and
calculating the expected power usage associated with powering down the RF chain as a sum of the determined amount of power required to power up the components of the RF chain and the determined amount of power required to rewrite all of the configuration registers of the RF chain.

12. The method of claim 10, wherein calculating an expected power usage associated with placing the RF chain in the low-power mode comprises:
determining an amount of power required to maintain the values stored in the configuration registers of the RF chain during the determined period of time;
determining an amount of power required to update only configuration registers of the RF chain specific to a subscription associated with upcoming reception activities; and
calculating the expected power usage associated with placing the RF chain in the low-power mode as a sum of the determined amount of power required to maintain the values stored in the configuration registers of the RF chain and the determined amount of power required to update only configuration registers specific to the subscription associated with the upcoming reception activities.

13. A mobile communication device, comprising:
a memory;
a radio-frequency (RF) chain; and
a processor coupled to the memory, a Subscriber Identity Module (SIM), and the RF chain, wherein the processor is configured to:
determine a period of time that the RF chain will not be transmitting or receiving;
determine whether powering down the RF chain for the determined period of time would yield net power savings;
place the RF chain in a low-power mode that retains values stored in configuration registers of the RF chain in response to determining that powering down the RF chain for the determined period of time would not yield net power savings; and
power down the RF chain in response to determining that powering down the RF chain for the determined period of time would yield net power savings.

14. The mobile communication device of claim 13, wherein values stored in the configuration registers of the RF chain are not retained when the RF chain is powered down.

15. The mobile communication device of claim 13, wherein when the RF chain is powered down the RF chain is in a state that draws less power than when the RF chain is in the low-power mode.

16. The mobile communication device of claim 13, wherein the processor is further configured to determine whether powering down the RF chain for the determined period of time would yield net power savings based on a period of time required to power up the RF chain.

17. The mobile communication device of claim 13, wherein:
the SIM comprises at least one SIM; and
the RF chain comprises at least one RF chain.

18. The mobile communication device of claim 13, wherein the processor is further configured to determine a period of time the RF chain will be idle based on an end time of currently serviced reception activities and a start time of upcoming reception activities.

19. The mobile communication device of claim 13, wherein the processor is further configured to:
determine a minimum amount of time that the RF chain must be powered down to achieve net power savings;
determine whether the minimum amount of time exceeds the determined period of time; and
place the RF chain in the low-power mode in response to determining that the minimum amount of time exceeds the determined period of time.

20. The mobile communication device of claim 13, wherein the processor is further configured to:
determine whether a subscription associated with upcoming reception activities matches a subscription associated with reception activities the RF chain serviced most recently; and
update only those configuration registers of the RF chain that are specific to the subscription associated with the upcoming reception activities in response to determining that the subscription associated with the upcoming reception activities does not match the subscription associated with the reception activities the RF chain serviced most recently.

21. The mobile communication device of claim 20, wherein the processor is further configured to:
determine a communication protocol of the subscription associated with the upcoming reception activities;
perform a table lookup to identify configuration registers of the RF chain associated with enabling the RF chain to use the communication protocol; and
update only the identified configuration registers to enable the RF chain to service the subscription associated with the upcoming reception activities.

22. The mobile communication device of claim 13, wherein the processor is further configured to:
calculate an expected power usage associated with powering down the RF chain for the determined period of time;
calculate an expected power usage associated with placing the RF chain in the low-power mode for the determined period of time;
determine whether the expected power usage associated with powering down the RF chain exceeds the expected power usage associated with placing the RF chain in the low-power mode; and
place the RF chain in the low-power mode in response to determining that the expected power usage associated with powering down the RF chain exceeds the expected power usage associated with placing the RF chain in the low-power mode.

23. The mobile communication device of claim 22, wherein the processor is further configured to:
determine an amount of power required to reinitialize components of the RF chain that would be powered down during the determined period of time;
determine an amount of power required to rewrite all the configuration registers of the RF chain; and
calculate the expected power usage associated with powering down the RF chain as a sum of the determined amount of power required to power up the components of the RF chain and the determined amount of power required to rewrite all of the configuration registers of the RF chain.

24. The mobile communication device of claim 22, wherein the processor is further configured to:
determine an amount of power required to maintain the values stored in the configuration registers of the RF chain during the determined period of time;
determine an amount of power required to update only configuration registers of the RF chain specific to a subscription associated with upcoming reception activities; and
calculate the expected power usage associated with placing the RF chain in the low-power mode as a sum of the determined amount of power required to maintain the values stored in the configuration registers of the RF chain and the determined amount of power required to update only configuration registers specific to the subscription associated with the upcoming reception activities.

25. A non-transitory processor-readable storage medium having stored thereon processor-executable instructions configured to cause a processor of a mobile communication device to perform operations comprising:
determining a period of time that a radio-frequency (RF) chain will not be transmitting or receiving;
determining whether powering down the RF chain for the determined period of time would yield net power savings;
placing the RF chain in a low-power mode that retains values stored in configuration registers of the RF chain in response to determining that powering down the RF chain for the determined period of time would not yield net power savings; and
powering down the RF chain in response to determining that powering down the RF chain for the determined period of time would yield net power savings.

26. The non-transitory processor-readable storage medium of claim 25, wherein the stored processor-executable instructions are configured to cause the mobile communication device processor to perform operations for determining a period of time that the RF chain will not be transmitting or receiving, the operations comprising determining a period of time the RF chain will be idle based on an end time of currently serviced reception activities and a start time of upcoming reception activities.

27. The non-transitory processor-readable storage medium of claim 25, wherein:
the stored processor-executable instructions are configured to cause the mobile communication device processor to perform operations for determining whether powering down the RF chain for the determined period of time would yield net power savings, the operations comprising:
determining a minimum amount of time that the RF chain must be powered down to achieve net power savings; and
determining whether the minimum amount of time exceeds the determined period of time; and
the stored processor-executable instructions are configured to cause the mobile communication device processor to perform operations for placing the RF chain in a low-power mode that retains values stored in configuration registers of the RF chain, the operations comprising placing the RF chain in the low-power mode in response to determining that the minimum amount of time exceeds the determined period of time.

28. The non-transitory processor-readable storage medium of claim 25, wherein the stored processor-executable instructions are configured to cause the mobile communication device processor to perform operations further comprising:
determining whether a subscription associated with upcoming reception activities matches a subscription associated with reception activities the RF chain serviced most recently; and
updating only those configuration registers of the RF chain that are specific to the subscription associated with the upcoming reception activities in response to determining that the subscription associated with the upcoming reception activities does not match the subscription associated with the reception activities the RF chain serviced most recently.

29. The non-transitory processor-readable storage medium of claim 28, wherein the stored processor-executable instructions are configured to cause the mobile communication device processor to perform operations for updating only configuration registers specific to the subscription associated with the upcoming reception activities, the operations comprising:
determining a communication protocol of the subscription associated with the upcoming reception activities;
performing a table lookup to identify configuration registers of the RF chain associated with enabling the RF chain to use the communication protocol; and
updating only the identified configuration registers to enable the RF chain to service the subscription associated with the upcoming reception activities.

30. A mobile communication device, comprising:
means for determining a period of time that a radio-frequency (RF) chain will not be transmitting or receiving;
means for determining whether powering down the RF chain for the determined period of time would yield net power savings;
means for placing the RF chain in a low-power mode that retains values stored in configuration registers of the RF chain in response to determining that powering down the RF chain for the determined period of time would not yield net power savings; and
means for powering down the RF chain in response to determining that powering down the RF chain for the determined period of time would yield net power savings.
